(19) United States
(12) Patent Application Publication
(10) Pub. No.: US 2023/0107317 A1
(43) Pub. Date: Apr. 6, 2023

(54) Turbine Device

(71) Applicant: TE Connectivity Sensors France, Toulouse (FR)

(72) Inventors: Emilien Durupt, Toulouse (FR); Damien Andreu, Toulouse (FR)

(73) Assignee: TE Connectivity Sensors France, Toulouse (FR)

(21) Appl. No.: 17/956,921

(22) Filed: Sep. 30, 2022

(30) Foreign Application Priority Data
Sep. 30, 2021 (EP) 21306353.0

(51) Int. Cl. F02C 9/26

(52) U.S. Cl. CPC F02C 9/26; F05D 2220/32; F05D 2220/76; F05D 2270/30

(57) ABSTRACT

A turbine device includes a fluid compressing device compressing a fluid, a combustion device, a fuel supply device supplying a fuel to the combustion device, the combustion device combusting a mixture of the fluid and the fuel, a sensing device, and a control device. The sensing device senses a humidity of the fluid compressed in the fluid compressing device. The control device controls the supply of the fuel by the fuel supply device based on the humidity sensed by the sensing device.

### CROSS-REFERENCE TO RELATED APPLICATIONS

This application claims the benefit of the filing date under 35 U.S.C. § 119(a)-(d) of European Patent Application No. 21306353.0, filed on Sep. 30, 2021.

### FIELD OF THE INVENTION

The present invention relates to a turbine device and a method of operating a turbine device.

### BACKGROUND

Turbine devices are known in the art and are used to extract drive power from the energy released in a combustion reaction of a fuel with an oxidizing agent contained in a working fluid. These devices are implemented in various applications, for example as part of engines to drive aircraft, motor vehicles, sea vessels, helicopters, or in power plants to drive the electrical generators. Device control units are used to control the combustion reactions of said turbine devices. The device control units collect and process a number of machine data points, such as for example turbine rounds-per-minute, device temperatures, device pressures or throttle lever position, to control device operating parameters.

The characteristics of the working fluid influence the device operation and performance. In particular, the composition of the working fluid may include a portion of water, which can significantly affect the drive power generated. On the one hand, liquid water in the form of droplets or condensation can reduce compression efficiency, thermal cycle efficiency or compressor blade lifespan, and interfere with pressure instrumentation. On the other hand, water contained in the working fluid in the form of vapor modifies said fluid’s thermodynamic properties. In particular, it modifies the fluid’s specific heat capacity at constant pressure, which impacts the temperature resultant from the combustion reaction. The combustion temperature in turn determines drive power, fuel efficiency, as well as the quantity and proportion of pollutant combustion emissions.

At the same time, many turbine devices are at risk of being subjected to significant swings in the water content of the working fluid, in line with ambient conditions at the location of the device. For turbine devices using ambient air as working fluid, such swings may commonly result from seasonalities, climate fluctuations, shifts in device altitude or meteorological eventualities.

This presents a difficulty for the control of fuel quantity supplied to the combustion device for combustion with the working fluid. Conventional techniques have sought to remedy this difficulty, for example by modelling humidity based on temperature values. However, these techniques present inherent limitations to accuracy and reliability of the drive power obtained from a specific fuel control.

### SUMMARY

A turbine device includes a fluid compressing device compressing a fluid, a combustion device, a fuel supply device supplying a fuel to the combustion device, the combustion device combusting a mixture of the fluid and the fuel, a sensing device, and a control device. The sensing device senses a humidity of the fluid compressed in the fluid compressing device. The control device controls the supply of the fuel by the fuel supply device based on the humidity sensed by the sensing device.

### BRIEF DESCRIPTION OF THE DRAWINGS

The invention will now be described by way of example with reference to the accompanying Figures, of which:

FIG. 1 is a sectional side view of a turbine device according to an embodiment;

FIG. 2 is a side and perspective view of a sensor for sensing humidity according to an embodiment; and

FIG. 3 is a flowchart of a method of operating a turbine device.

### DETAILED DESCRIPTION OF THE EMBODIMENT(S

The invention shall be explained hereafter in more detail by way of example using embodiments with reference to the drawings. The feature combinations illustrated in the embodiments by way of example can be supplemented by further features in accordance with the properties of the devices of the invention that are demanded for a specific application. Individual features can also be omitted in the embodiments described if the effect of this feature is irrelevant for a specific case of application. The same reference numerals in the drawings are used for elements having the same function and/or the same structure.

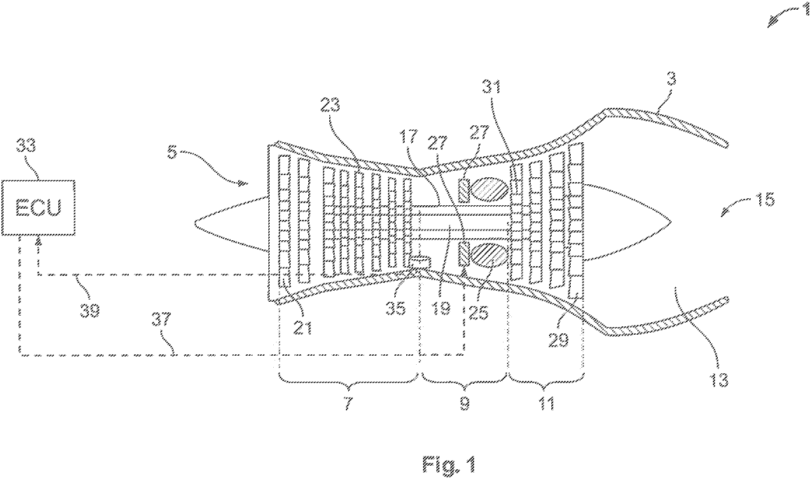

FIG. 1 displays a cross-sectional view of an embodiment of the turbine device according to the invention. In this embodiment, the turbine device 1 comprises a nacelle 3, an inlet 5 with a fluid compressing device 7, a combustion device 9, a turbine section 11, a nozzle 13, and an outlet 15. The turbine device 1 illustrated is a jet engine, which may be designated as twin-spool turbojet. However, the invention can be applied to any kind of turbine device, such as a turbofan engine, turboprop engine, turboshaft engine, an automotive piston engine equipped with a turbocharger or an electrical generator gas turbine. In this embodiment, the working fluid, namely ambient air delivered from the inlet 5, is subjected to a pressure increase by compression in the compressing device 7 and a temperature increase by heat energy supply in the combustion device 9. Expansion of the heated and pressurized fluid through the turbine section 11 produces torque onto shafts 17 and 19, and expansion in the nozzle 13 produces thrust onto the nacelle 3.

The compressing device 7 accelerates fluid delivered from the inlet 5 and converts the resulting kinetic energy into potential energy of pressure. It comprises for a first compression stage a low pressure compressor 21 arranged on an inner low pressure shaft 19, and a high pressure compressor 23 arranged on an outer high pressure shaft 17 for a second compression stage. The compression ratio of the device is a critical parameter of overall thermal cycle efficiency. Resulting pressures after compression may exceed 25bar.

The combustion device 9 is arranged downstream from the compressing device and comprises a combustor 25, which is linked to a fuel supply device 27. The combustor 25 serves as a combustion chamber where the combustion reaction occurs. Combustion occurs between the compressed fluid, here compressed air, and a fuel, for example kerosene, injected by the fuel supply device 27. The fuel supply device 27 is responsible for delivering fuel to the combustor for the combustion reaction. The fuel supply device 27 may draw fuel via a flow link from a fuel reservoir and supply it to the combustor 25 via a fuel injector. The combustion device 9 may further include a diffusion device, swirling device, ignition device, et alia which are not represented in FIG. 1.

The turbine section 11 downstream of the combustion device 9 comprises a low pressure turbine 29 and a high pressure turbine 31. The low pressure turbine 29 and the low pressure compressor 21 are mounted on the common low pressure shaft 19. The high pressure turbine 31 and the high pressure compressor 23 are mounted on the separate outer high pressure shaft 17 coaxially aligned over the low pressure shaft 19. As the shafts 17 and 19 rotate mechanically independently, the low and high pressure compressors 21 and 23 are driven by separate turbines 29, 31, which allows for higher compression ratios while avoiding stability problems at low flow rates.

The turbine device further comprises a control device 33. Typically, the control device 33 takes the form of a digital computer called electronic control unit (ECU). However, the control device 33 may comprise any combination of digital, hydro-mechanical, electronic, or other devices. The ECU may be integrated in a larger control system such as a Full Authority Digital Electronic Control (FADEC) system, which controls all aspects of a vehicle. The control device 33 is used to control the fuel supply device 27.

According to the invention, the turbine device 1 further comprises a sensing device 35 for humidity sensing. In this embodiment of FIG. 1, the sensing device 35 for sensing humidity is a humidity sensor placed on an inner surface of the nacelle 3 in between the compressing device 7 and the combustion device 9. In such an arrangement, the humidity of the working fluid is sensed in its compressed state just before combustion. At the same time, the measurement is less at risk of being contaminated by the effects of the combustion, in particular the change of constitution of the working fluid resulting from the combustion. This arrangement would thus allow for an especially representative measurement of working fluid humidity for combustion.

The sensing device 35, could, however, also be positioned differently, for example on a surface of the outer shaft 17, or in between low-pressure compressor 21 and high-pressure compressor 23, or adjacent to the combustor 25 inlet, or inside the combustion device 9 adjacent to a combustor 25 casing.

In an embodiment, the sensing device 35 comprises a capacitive and/or resistive sensing element. These sensing elements experience a change in capacitance and/or according to with water vapor and this effect can be used to determine humidity. This type of sensing device provides good accuracy, while being compact and easy to mount. Thus, it is particularly suitable to be integrated in already designed and currently manufactured turbines devices. Sensing device may use porous or non-porous, inorganic, metallic or nanostructured thin films as sensing elements.

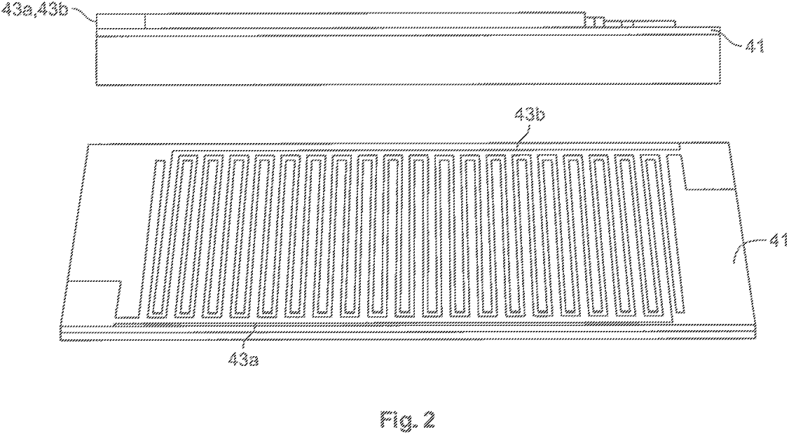

FIG. 2 illustrates such a humidity sensor which may be used as sensing device 35 for sensing humidity in an embodiment. The sensor comprises a capacitive sensing element 41 in the form of an inorganic dielectric layer and provides fast sub-second sensing response times, as well as high resistance to harsh environments. This type of sensing element may allow for higher durability and resistance to chemical ageing effects of the sensor, as opposed to for example sensing elements based on organic polymers. Thus, the inorganic dielectric layer sensor of FIG. 2 is suited to the aggressive environments that occur after compression and/or close to the combustion, of the turbine device 1.

In various embodiments, the sensing device can be configured to operate at temperatures which exceed 250° C., exceed 325° C. and, or exceed 400° C. In various embodiments, the sensing device may be configured to operate at pressures which exceed 15 bar, 20 bar and even above 25 bar. In particular, these sensors can be configured to operate at temperatures above 400° C. and pressures above 25 bar found in said post-compression environments. Examples of such sensors are described in EP 3 495 807 A1 or EP 3 584 570 A1, their description is included herewith by reference.

In a further refinement of previous embodiment, said inorganic dielectric layer 41 may be arranged with interdigitated electrodes 43a, 43b, as shown in FIG. 2. This type of combination may be conveniently and cost-efficiently mass-produced with common industrial semiconductor manufacturing or high-yield microfabrication techniques. EP 3 812 754 A1 provides an example of such a sensor, the description of which is incorporated by reference.

The sensing device 35 provides an output signal 37, which may take electrical, mechanical, electromagnetic or any further conceivable form and is relayed to control device 33 as shown in the embodiment of FIG. 1. The control device 33 receives an input 37 in form of a signal representative of working fluid humidity from the sensing device 35, and controls fuel supply by an output signal 39 as a lever of regulation for the fuel flow, for example using a signal destined to a fuel injector pressure pump. The control device 33 determines the fuel quantity to be supplied for combustion, and may further determine mode and location of fuel supply.

Typically, control device 33 take into account various input data to determine the quantity of fuel to be injected. According the invention, the control device 33 takes into account an accurate humidity value of the compressed working fluid from the sensing device 35.

By providing the sensing device 35, the water content of the turbine device working fluid can be determined with accuracy and reliability at a post-compression stage. At this stage, working fluid properties are relevant for combustion control. The knowledge of the water fraction allows for improved determination of fuel quantity needed to achieve a desired combustion temperature, and thus improved control of power output, fuel efficiency, and pollutant emission. The sensing device 35 may take the form of any apparatus with the ability to provide an output signal in direct relationship with a value representative of water fraction in the working fluid, such as relative humidity, absolute humidity or similar.

The accurate humidity value is generally beneficial for control of one or more device parameters, as the water content of the working fluid influences its primary physical properties such as molecular weight and density. In particular, the water content determines the specific heat capacity at constant pressure of the working fluid, and consequently the amount of heat that must be delivered so as to obtain a desired temperature increase. Since, in the context of a turbine device thermodynamically modeled as heat engine, fuel supply destined to combustion device may be idealized as heat supply, such a humidity measurement of the compressed working fluid is particularly of interest for control of the combustion reaction. By more accurately determining the working fluid’s specific heat capacity, the combustion reaction dynamic in relation to fuel quantity provided for combustion can be more accurately predicted. A higher level of ‘tuning’ or calibrating of combustion temperatures around optimal target temperatures is thus possible.

Sensing the humidity of the compressed fluid directly provides a humidity value that is independent of the use of additional measurements or physical properties. Thus, fewer implementation efforts and computational steps for determination of post-compression working fluid water content are required. The humidity determination is therefore more reliable and less prone to accuracy-diluting error factors.

The improved level of control of the combustion temperatures may permit the reduction of safety tolerances included in the maximal temperature design points with respect to critical metallurgical limits. As device materials are subjected to creep effects, high temperatures may deform or meld device components, in particular the highly stressed metallic blades of turbines 29 and 31 in contact with the heated combustion device 9 exhaust fluid. Thus, material creep strength and life span requirements impose critical temperature values which limit maximal allowable temperature, and thus peak power output. An improved level of control of the combustion temperature may thus increase maximal device power output, which may in turn reduce specific fuel consumption of the device. This could reduce operational costs and ferry range of a vehicle.

An additional advantage from improved control of the combustion temperature is obtained with regard to pollutant emissions exhausted from the turbine device 1. Higher fuel efficiencies of a hydrocarbon combustion reaction implies lower emissions of greenhouse gases such as water vapor and carbon dioxide, as well as lower emission of unburnt fuel. Further, it has been established that the temperature of a hydrocarbon-fuel combustion reaction has a strong influence on the constitution of reaction byproducts, such as nitrogen oxides, carbon monoxide or ozone. Thus, improved control of combustion temperatures may improve the achievement of pollutant emission targets.

It must be noted that a large variety of device configurations, and in particular of compressing device 7 and turbine section 11 arrangements, have been conceived and may be applied to the present invention. Alternative embodiments may include variation of the number of rotors per turbine or compressor, the addition of further spools of compressor or of turbine, addition of stator blades to the nacelle for compression, addition of gears for adaptation of shaft power transmission or direction, non-axial alignments of the flow series, alternative compressor technologies such as centrifugal or mixed-flow compression, the addition of a cooling mechanism for the turbine blades, of an afterburners post-turbine-section, of water injection into the compression section, of variable stator blades to the compressing device, and many more.

Typically, multiple-shaft arrangements may be more adapted when variable speed loads and easy starting is required, such as in vehicles. For example, in an embodiment of the turbine device 1, the twin-spool device of FIG. 1 can drive a ducted fan mounted coaxially on the inner low-pressure shaft 19, such as in turbofan engines. Similarly, the turbine device can in other embodiments be arranged to drive a propeller such as in turboshaft or turboprop engine, advantageously with an adaptable power transmission through a gear box. Such an engine could drive a vehicle, such as an airplane, a helicopter or a sea vessel, with improved humidity sensing.

In another embodiment, a generator is powered by the turbine device of the invention. Single-shaft arrangements may be more adapted to stationary high base-load power generation requirements of such ground-based turbines. The stringent requirements of low emissions placed upon said generators, while demanding stable operation, make accurate humidity measurement particularly useful for accurate combustion temperature control.

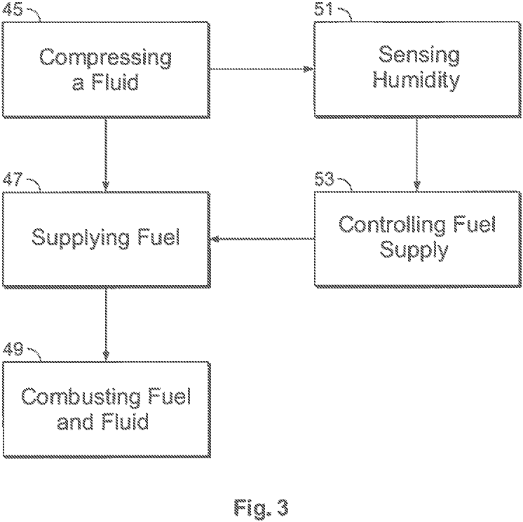

A method of operating a turbine device will now be described with reference to FIG. 3 according to a second embodiment of the invention. For example, the turbine device according to the first embodiment as illustrated in FIG. 1 may be operated according to the inventive method. As shown in FIG. 3, several steps are performed in sequence. The method starts with process step 45 of compressing a fluid. For example, a fluid serving as working fluid of a turbine device 1 is compressed, wherein said fluid entered via the inlet 5 and is compressed by the compressing device 7.

In step 47, fuel is supplied and mixed with the compressed fluid, so as to provide conditions for a combustion reaction to occur. For example, a fuel supply device 27 delivers fuel via pressurized injection to a combustor 25, where said fuel is mixed with the compressed fluid. In step 49, said mixture of fluid and fuel is combusted, for example in a combustion device 9.

According to the invention, the humidity of the fluid compressed in step 45 is sensed in a further step 51. In this embodiment of the method, the step 51 of sensing humidity is enacted between a compressing device and a combustion device, such as items 7 and 9 of FIG. 1, thus within a rather harsh environment. Sensing takes place at temperatures which exceed 400° C. and pressures which exceed 25 bar, such as may occur in typical operation of the turbine device embodiment of FIG. 1.

In a further step 53, the quantity of fuel supplied in step 47 is controlled according to the humidity content sensed in step 51. With this method, the turbine device can be operated with an improved accuracy of combustion temperature control. As described in the previous part relating to the turbine device, operating the control based on the sensed humidity values provides the benefit of allowing an increase of peak power output and reducing specific power consumption of the device.

Modifications to the embodiments and combinations of embodiments of the invention described in the forgoing are possible without departing from the scope of the invention as defined by the scope of the accompanying claims. Expressions such as “including”, “comprising”, “consisting of”, “have”, and “is” used to describe and claim the present invention are intended to be construed in a non-exclusive manner, namely allowing for items, components or elements not explicitly described also to be present. Reference to the singular is also construed to be related to the plural.

What is claimed is:

1. A turbine device, comprising:
a fluid compressing device compressing a fluid;
a combustion device;
a fuel supply device supplying a fuel to the combustion device, the combustion device combusting a mixture of the fluid and the fuel;
a sensing device sensing a humidity of the fluid compressed in the fluid compressing device; and
a control device controlling the supply of the fuel by the fuel supply device based on the humidity sensed by the sensing device.

2. The turbine device of claim 1, wherein the sensing device has a capacitive and/or a resistive humidity sensing element.

3. The turbine device of claim 2, wherein the sensing device has an inorganic dielectric sensing layer.

4. The turbine device of claim 3, wherein the sensing device has a pair of interdigitated electrodes formed over the inorganic dielectric sensing layer.

5. The turbine device of claim 1, wherein the sensing device is arranged between the fluid compressing device and the combustion device.

6. The turbine device of claim 1, wherein the sensing device operates at temperatures above 250° C.

7. The turbine device of claim 6, wherein the sensing device operates at temperatures above 325° C.

8. The turbine device of claim 7, wherein the sensing device operates at temperatures above 400° C.

9. The turbine device of claim 1, wherein the sensing device operates at pressures above 15 bar.

10. The turbine device of claim 9, wherein the sensing device operates at pressures above 20 bar.

11. The turbine device of claim 10, wherein the sensing device operates at pressures above 25 bar.

12. An engine, comprising:
a turbine device including a fluid compressing device compressing a fluid, a combustion device, a fuel supply device supplying a fuel to the combustion device, the combustion device combusting a mixture of the fluid and the fuel, a sensing device sensing a humidity of the fluid compressed in the fluid compressing device, and a control device controlling the supply of the fuel by the fuel supply device based on the humidity sensed by the sensing device.

13. The engine of claim 12, further comprising a ducted fan and/or a propeller.

14. A generator, comprising:
a turbine device including a fluid compressing device compressing a fluid, a combustion device, a fuel supply device supplying a fuel to the combustion device, the combustion device combusting a mixture of the fluid and the fuel, a sensing device sensing a humidity of the fluid compressed in the fluid compressing device, and a control device controlling the supply of the fuel by the fuel supply device based on the humidity sensed by the sensing device.

15. A method of operating a turbine device, comprising:
compressing a fluid;
supplying a fuel;
combusting the compressed fluid and the supplied fuel;
sensing a humidity of the compressed fluid; and
controlling the supply of fuel based on the sensed humidity.

16. The method of claim 15, wherein the humidity is sensed between a compressing device and a combustion device of the turbine device.

17. The method of claim 15, wherein the humidity is sensed at temperatures of the fluid above 250° C.

18. The method of claim 15, wherein the humidity is sensed at pressures of the fluid above 15 bar.
